(19) United States
(12) Patent Application Publication
(10) Pub. No.: US 2003/0074751 A1
(43) Pub. Date: Apr. 24, 2003

(54) Electrical toothbrushes

(76) Inventor: Ka Shing Wu, Hong Kong (HK)

Correspondence Address: JACKSON WALKER L.L.P., Suite 2100, 112 E. Pecan Street, San Antonio, TX, 78205, US

(21) Appl. No.: 10/044,584

(22) Filed: Oct. 23, 2001

(51) Int. Cl. A61C 17/22

(52) U.S. Cl. 15/22.1; 15/28

(57) ABSTRACT

An electric toothbrush includes a brush head to which there is pivotally mounted a main bristle holder. Extending from the brush head is an auxiliary bristle holder which can oscillate in unison with the main bristle holder or in contra-rotational unison with the main bristle holder to increase efficiency of the toothbrush in operation.

### BACKGROUND OF THE INVENTION

1. Field of the Invention

The invention relates to electric toothbrushes.

2. Description of Prior Art

An electric toothbrush has been described in U.S. Pat. No. 5,784,743. That US Patent discloses an electric toothbrush having a brush head to which there is mounted a bristle holder that pivots back and forth about a pivot axis. The specification describes a drive shaft having a finger which rotates about an axis to effect movement of a plate which interacts with a gear which is attached to a bristle holder. Movement of the plate by the finger results in oscillatory pivotal movement of the bristle holder.

Irrespective of any specific mechanism by which the bristle holder of such toothbrushes is driven, operational efficiency is limited by the simple oscillatory movement of bristle holder with respect to the brush head.

### SUMMARY OF THE INVENTION

It is an object of the present invention to overcome or substantially ameliorate the above disadvantage.

It is a further object of the present invention to provide an electric toothbrush having a pivotally oscillating head as well as an auxiliary head extending from the toothbrush.

It is further object of the invention to provide an electric toothbrush having a main bristle holder that oscillates pivotally and an auxiliary bristle holder that oscillates pivotally alongside the main bristle holder.

According to the invention there is provided an electric toothbrush having a handle, a brush head, a main bristle holder mounted to the brush head and driven to oscillate pivotally with respect to the brush head, and an auxiliary bristle holder positioned radially outwardly of the main bristle holder and driven to oscillate pivotally with respect to the brush head.

Preferably the auxiliary bristle holder is attached to the brush head and is driven to move in a clockwise direction when the main bristle holder moves in a clockwise direction.

Preferably the auxiliary bristle holder is attached to the brush head and is driven to move in a counter-clockwise direction when the main bristle holder moves in a clockwise direction.

Preferably the auxiliary bristle holder is attached to the main bristle holder.

Preferably the auxiliary bristle holder is formed integrally with the main bristle holder.

Preferably the auxiliary bristle holder is attached to the main bristle holder by a spring plate.

Preferably, the electric toothbrush has a central longitudinal axis extending between the handle and the brush head, a drive shaft extending along the longitudinal axis from a motor in the handle to a remote and thereof and said drive shaft having a finger of f-set from the central axis at the remote end, a plate pivotably mounted on the central axis having a first end and a second end, a fork at the first end of the plate that embraces the finger and an arcuate contact drive surface at the second end, the main bristle holder being pivotably mounted by a shaft on the central axis to the brush head, and a circular contact surface rotatable with the shaft that engages the arcuate contact surface such that when the drive shaft is rotated by the motor continuously in one direction the main bristle holder is rotated backwards and forwards.

Preferably the auxiliary bristle holder is mounted to the plate.

Preferably, the toothbrush further includes a yolk on the brush head against which the auxiliary bristle holder moves so as to cause movement of the auxiliary bristle holder in a direction substantially normal to said clockwise and anticlockwise directions.

Preferably, the toothbrush further includes a yolk on the brush head against which the auxiliary bristle holder moves so as to cause movement of the auxiliary bristle holder in a direction substantially normal to said clockwise and anticlockwise directions.

Preferably the auxiliary bristle holder is attached to the main bristle holder by a spring plate.

### BRIEF DESCRIPTION OF THE DRAWINGS

Preferred forms of the present invention will now be described by way of example with reference to the accompanying drawings wherein:

FIG. 1 is a part-sectional underplan view of a toothbrush;

FIG. 2 is a bottom plan sectional views of part of the toothbrush of FIG. 1;

FIG. 3 is a side sectional elevation of part of the toothbrush of FIG. 1;

FIG. 4 is an enlarged plan view of a plate for the toothbrush of FIG. 1;

FIG. 5 is a part-sectional underplan view of another toothbrush;

FIG. 6 is a bottom plan sectional view of part of the toothbrush of FIG. 5;

FIG. 7 is a side sectional elevation of part of the toothbrush of FIG. 5;

FIG. 8 is an enlarged plan view of a plate for the toothbrush of FIG. 5;

FIG. 9 is an enlarged elevational view of brush head portion of either of the toothbrushes of FIG. 1 or FIG. 5;

FIG. 10 is an end elevational view of the brush head of FIG. 9; and

FIG. 11 is a cross-sectional elevational view of the brush head portion of the toothbrush as illustrated in FIG. 9.

### DESCRIPTION OF THE PREFERRED EMBODIMENT

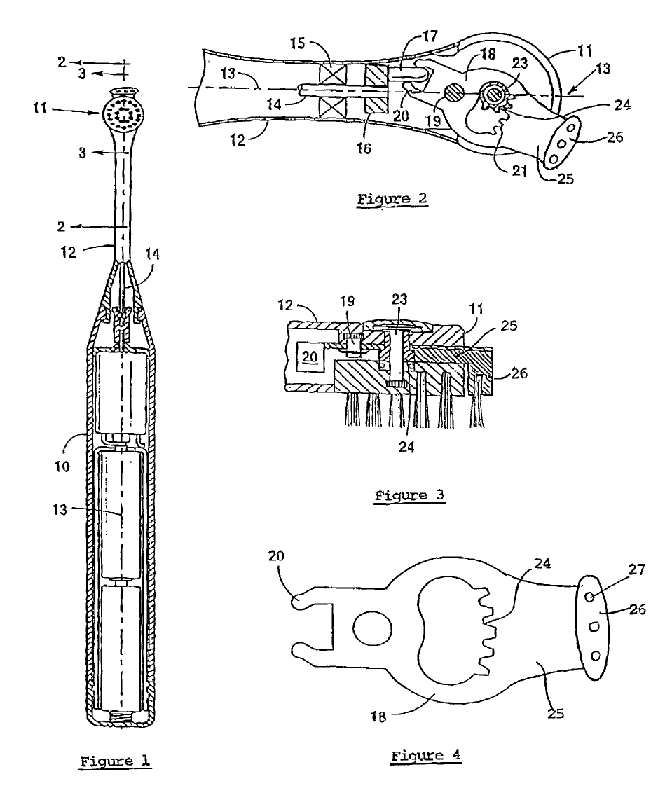

As shown in FIG. 1 of the drawings a first form of the toothbrush comprises a handle 10 a brush head 11 and shank 12 having a central longitudinal axis 13.

In FIGS. 2, 3 and 4, a drive shaft 14 is mounted to rotate about the central axis 13 and is held in position at a remote end by a bearing 15. A boss 16 mounted on the remote end of the shaft 14 is provided with a finger 17 that is off-set from the central axis 13. A wobble plate 18 is integrally mounted on a short shaft 19 on the axis 13 fixed to the brush head 11. The wobble plate 18 has a first end integrally formed as a fork 20 that embraces the finger 17 and a second end which carries an arcuate gear 21. A main bristle holder 22 is integrally mounted on a pivot shaft 23 also on the central axis 13 fixed to the brush head 11. The shaft 23 is provided with a gear 24 rotatably fixed to the shaft, that meshes with the arcuate gear 21.

When the drive shaft 14 is rotated continuously in one direction the main bristle holder 22 is caused to rotate backwards and forwards or oscillate about its central pivot axis. In general terms, the relative positoin of the shaft 19 and the shaft 23 can be varied significantly and the gearing between the gears 21 and 24 altered to produce various arcs of oscillation that may be desired. The arcs of oscillation can range well above 120° for example

The plate 18 (seen best in FIG. 4) is an integrally formed molded plastic part. The drive shaft 14 may also be integrally formed in plastic material or formed of steel wire where the finger 17 is formed by cranking the remote end of the wire.

As shown in FIGS. 2, 3 and 4, the plate 18 has an extension portion 25 which extends radially beyond brush head 11. At the distal end of the extension 25 there is integrally provided an auxiliary bristle holder 26. Bristles of the auxiliary bristle holder 26 reside alongside the bristle of the main bristle holder 22. When plate 18 oscillates pivotally by action of finger 17, the auxiliary bristle holder 26 also oscillates. The pivot axis of bristle head 26 is that of the shank 19 to which the plate 18 is mounted. When the plate 18 moves in a clockwise direction about this axis, the main bristle holder 22 also rotates in a clockwise direction due to the interaction of arcuate gear 21 with gear 24.

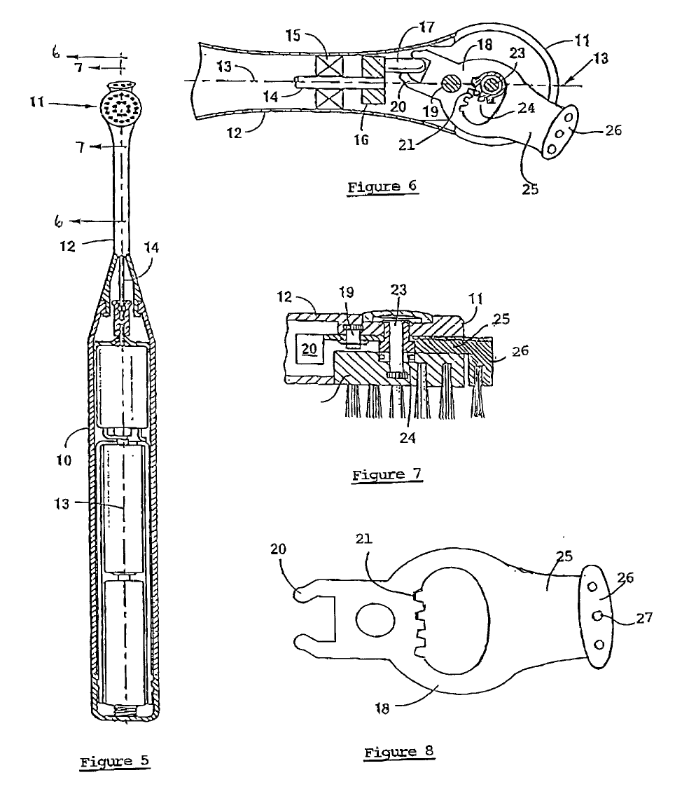

A second form of the toothbrush is depicted in FIGS. 5 to 8. In this embodiment, all features of the toothbrush are the same as those of the embodiment of FIG. 1, however, the auxiliary bristle holder 26 pivotably rotates in a direction opposite to that at which the mean bristle holder rotates at any given time. This is due to a relocation of arcuate gear 21 to the inner side of shaft 23. The gear 24 has been reposition upon shaft 23 so as to face backwardly such that its teeth inter-mash with the teeth of arcuate gear 21. As a result, when shaft 23 rotates in a clockwise direction the plate 18 rotates in a counter-clockwise direction. As a result, the main bristle holder 22 rotates counter-clockwise as the auxiliary bristle holder 26 rotates clockwise with the plate 18.

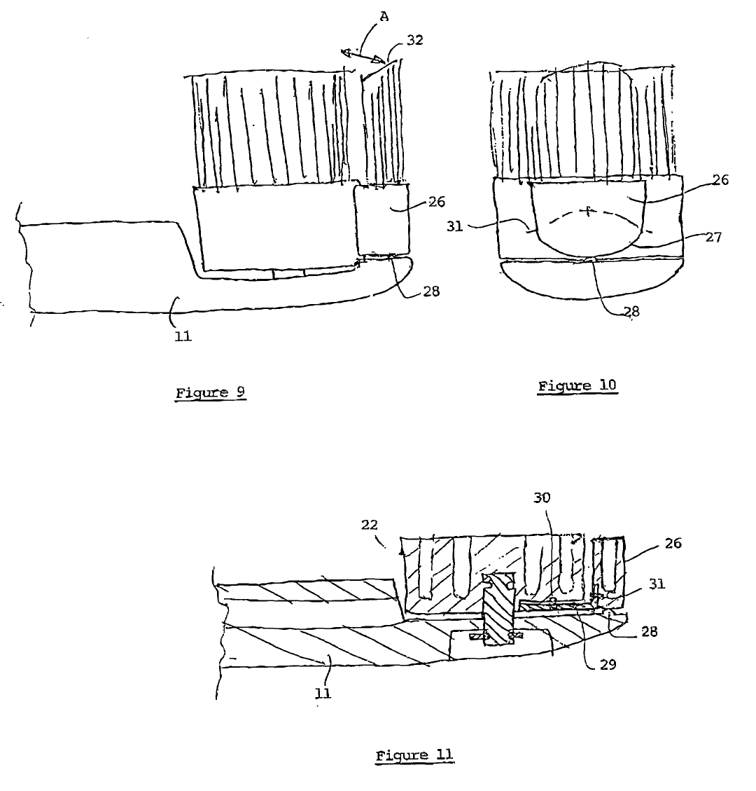

It might be desirable to provide a “3-dimensional” movement of auxiliary bristle holder 26. To this end a further embodiment of the invention is depicted in FIGS. 9 to 11.

As best illustrated in FIG. 11, the auxiliary bristle holder 26 is mounted to the main bristle holder 22 by a spring plate 29. Spring plate 29 can be soldered, riveted, spot-malted, plastic-melted or otherwise attached to main bristle holder 22 and auxiliary bristle holder 26. For the purpose of illustration, attachment lugs 30 and 31 are shown these may be plastic pins extending from the bristle holders through holes in the spring plate with melted-flat tops.

The auxiliary bristle holder 26 has a curved serface 27 that engages with a yolk 28 on the brush head 11. As the auxiliary bristle holder 26 moves across yolk 28, it is caused to follow a locus 31 by interaction of the curved serface 27 with the yolk 28.

In the embodiment depicted in FIGS. 9 to 11, the auxiliary bristles attached to the auxiliary bristle holder 26 have in combination, a tapered tip 32 as shown FIG. 9. This tip will have components of movement in the direction indicated by arrow A as well as components of movement about the axis of the main bristle holder 22. In this embodiment, the rotary component of movement of auxiliary bristle holder 26 is fixed by and therefore co-rotational with main bristle holder 22. However, where a contra-rotational auxiliary bristle holder 26 is desired, the embodiment of FIGS. 5 to 8 could be modified simply by the incorporation of a spring plate between plate 18 and auxiliary bristle holder 26 and the provision of a yolk on brush head 11 with which the auxiliary bristle holder can interact as described. As an alternative to the use of a separate spring plate, the plate 18 could be made from a thin sheet of resilient material such as stainless steel, or could be formed of a more rigid material having a thin portion at extension 25 formed integrally therewith to provide the necessary resiliency.

1. An electric toothbrush having a handle, a brush head, a main bristle holder mounted to the brush head and driven to oscillate pivotally with respect to the brush head, and an auxiliary bristle holder positioned radially outwardly of the main bristle holder and driven to oscillate pivotally with respect to the brush head.

2. The electric toothbrush of claim 1 in which the auxiliary bristle holder is attached to the brush head and is driven to move in a clockwise direction when the main bristle holder moves in a clockwise direction.

3. The electric toothbrush of claim 1 in which the auxiliary bristle holder is attached to the brush head and is driven to move in a counter-clockwise direction when the main bristle holder moves in a clockwise direction.

4. The electric toothbrush of claim 2 wherein the auxiliary bristle holder is attached to the main bristle holder.

5. The electric toothbrush of claim 5 wherein the auxiliary bristle holder is formed integrally with the main bristle holder.

6. The electric toothbrush of claim 5 wherein the auxiliary bristle holder is attached to the main bristle holder by a spring plate.

7. The electric toothbrush of claim 1 having a central longitudinal axis extending between the handle and the brush head, a drive shaft extending along the longitudinal axis from a motor in the handle to a remote and thereof and said drive shaft having a finger off-set from the central axis at the remote end, a plate pivotably mounted on the central axis having a first end and a second end, a fork at the first end of the plate that embraces the finger and an arcuate contact drive surface at the second end, the main bristle holder being pivotably mounted by a shaft on the central axis to the brush head, and a circular contact surface rotatable with the shaft that engages the arcuate contact surface such that when the drive shaft is rotated by the motor continuously in one direction the main bristle holder is rotated backwards and forwards.

8. The electric toothbrush of claim 7 wherein the auxiliary bristle holder is mounted to the plate.

9. The electric toothbrush of claim 2 further including a yolk on the brush head against which the auxiliary bristle holder moves so as to cause movement of the auxiliary bristle holder in a direction substantially normal to said clockwise and anticlockwise directions.

10. The electric toothbrush of claim 3 further including a yolk on the brush head against which the auxiliary bristle holder moves so as to cause movement of the auxiliary bristle holder in a direction substantially normal to said clockwise and anticlockwise directions.

11. The electric toothbrush of claim 9 wherein the auxiliary bristle holder is attached to the main bristle holder by a spring plate.
